(19) United States
(12) Patent Application Publication
(10) Pub. No.: US 2010/0139005 A1
(43) Pub. Date: Jun. 10, 2010

(54) Apparatus for carrying critical care equipment

(76) Inventor: Adolfo Perez, Alta Loma, CA (US)

Correspondence Address: JAMES E. BRUNTON, ESQ., P. O. BOX 29000, GLENDALE, CA, 91209, US

(21) Appl. No.: 12/316,286

(22) Filed: Dec. 10, 2008

(51) Int. Cl. A61G 1/04; F16M 13/02; A47C 31/00

(52) U.S. Cl. 5/658

(57) ABSTRACT

An easily transportable apparatus for carrying critical care equipment, such as an EKG unit, needed by a patient being transported on a conventional gurney, stretcher, or like patient transport device. The apparatus is adjustable so that it can be conveniently attached to gurneys having side rails with different spacing. Additionally, the apparatus includes an equipment support platform to which the critical care equipment can readily be connected and can be rotated 360 degrees so that the equipment can easily be viewed by caregivers located in both the front and rear of the transport vehicle.

### BACKGROUND OF THE INVENTION

1. Field of the Invention

The present invention relates generally to apparatus for carrying critical care equipment needed by a patient being transported on a conventional gurney. More particularly, the invention concerns an adjustable apparatus that carries critical care equipment such as EKG units and one that can be conveniently attached to standard gurneys having side rails of different spacing.

2. Discussion of the Prior Art

Accident victims as well as critically ill persons are typically transported to care facilities such as hospitals on standard collapsible stretchers or gurneys having spaced-apart side rails. During transport the vital functions of the patient are typically carefully monitored with units such as EKG units and the patient is often provided with oxygen and various intravenously administered medicaments. The supply of medicaments and the monitoring of vital body functions require the use of equipment and supplies that must be located in close proximity to the patient. Additionally, the medical supplies and the monitoring equipment must be readily accessible to the ambulance attendants to enable them to expeditiously attend to the needs of the patient.

Accordingly, a need exists for a compact, easy-to-use apparatus that can be readily interconnected with gurneys of various designs and one that will efficiently support critical care equipment in a manner such that during patient transport the equipment is readily accessible to and viewable by the ambulance attendants. Several attempts have been made in the past to provide such an apparatus. Representative of one such prior art attempt is the apparatus disclosed in U.S. Pat. No. 5,845,351 issued to Berta et al. This patent describes a stretcher table assembly for attachment over an ambulance stretcher. The stretcher table assembly includes a tray for securing medical equipment used during an emergency. A pair of legs extends away from the tray and includes attachment members for engaging the rails of the stretcher. The attachment members may include anti-skidding members providing frictional resistance between the attachment members and the rails. The legs are secured to the rails through a flexible strap. The flexible strap may be wrapped around the rail and secured. The flexible strap may also be used in conjunction with a hook which engages the rail. The flexible strap is then secured to hold the stretcher table assembly in place over the stretcher.

A somewhat similar prior art apparatus is disclosed in U.S. Pat. No. 6,446,285 issued to Chinn. This apparatus comprises a stretcher table assembly for attachment over an ambulance stretcher. The stretcher table assembly includes a tiltable support surface for securing emergency medical equipment. The tiltable support surface may be inclined to permit technicians to more easily view the equipment secured thereon. Additionally, the support surface has a grid of holes upon which anchoring devices may be positioned. The anchoring devices permit emergency medical equipment to quickly and easily secure to the support surface without the need of adjusting a strap or buckle. A pair of legs extends away from the support frame and has attachment feet for engaging the rails of the stretcher. Each of the legs is secured to the rails by an attached securing mechanism that holds the tiltable stretcher table assembly in place over the stretcher.

### SUMMARY OF THE INVENTION

It is an object of the present invention to provide an apparatus for carrying critical care equipment needed by a patient being transported on a conventional gurney, stretcher, or like patient transport device. More particularly, it is an object of the invention to provide an adjustable apparatus for carrying critical care equipment, such as EKG units that can be conveniently attached to standard gurneys having side rails with different spacing.

Another object of the invention is to provide an apparatus of the aforementioned character that includes an equipment support platform to which critical care equipment, such as an EKG, can readily be easily connected and one that can be rotated 360 degrees so that the critical care equipment can easily be viewed by ambulance attendants in both the front and rear of the transport vehicle.

Another object of the invention is to provide an apparatus of the character described in the preceding paragraph that further includes spaced-apart telescoping, support legs that are inter-connectable with the side rails of the gurney and are foldably connected to the equipment support platform so that the apparatus can be easily folded into a compact configuration for transport and storage.

Another object of the invention is to provide an apparatus of the character described in the preceding paragraph that further includes a locking mechanism for releasably locking the support legs of the apparatus in the retracted, stowed position.

Another object of the invention is to provide an apparatus of the class described that is light-weight, compact and easy to use.

The forgoing as well as other objects of the invention will be achieved by the novel apparatus illustrated in the drawings and described in the detailed description that follows.

### BRIEF DESCRIPTION OF THE DRAWINGS

FIG. 1 is a generally perspective view of one form of the apparatus of the invention as it appears when interconnected with the side rails of a conventional gurney.

FIG. 2 is a greatly enlarged, top plan view of the apparatus shown in FIG. 1.

FIG. 3 is a view taken along lines 3-3 of FIG. 2.

FIG. 4 is a view taken along lines 4-4 of FIG. 3.

FIG. 5 is a cross-sectional view taken along lines 5-5 of FIG. 4.

FIG. 6 is a cross-sectional view taken along lines 6-6 of FIG. 4.

FIG. 7 is a cross-sectional view taken along lines 7-7 of FIG. 4.

FIG. 8 is a cross-sectional view similar to FIG. 6, but showing the leg locking mechanism of the apparatus moved into a retracted, or release position.

FIG. 9 is a cross-sectional view similar to FIG. 7, but showing the leg assembly illustrated in FIG. 7 moved from the retracted position shown in FIG. 7 to an extended position.

FIG. 9A is a generally perspective view showing the method of inter-connection of the legs of the leg assemblies with the bight portions of the leg assemblies.

FIGS. 10A and 10B when considered together illustrate an end view of the apparatus of the invention with the leg assemblies of the apparatus in an extended position and with one of the legs of one of the leg assemblies shown in cross-section to illustrate internal construction.

FIG. 11 is a greatly enlarged cross-sectional view taken along lines 11-11 of FIG. 10A.

FIG. 12 is a view taken along lines 12-12 of FIG. 10A.

FIG. 13 is a greatly enlarged cross-sectional view taken along lines 13-13 of FIG. 12.

FIG. 14 is an end view of one form of the apparatus of the invention illustrating the extension of the leg assemblies of the apparatus to permit the apparatus to be releasably interconnected with a gurney having side rails of a different spacing from the gurney shown in FIG. 1.

### DESCRIPTION OF THE INVENTION

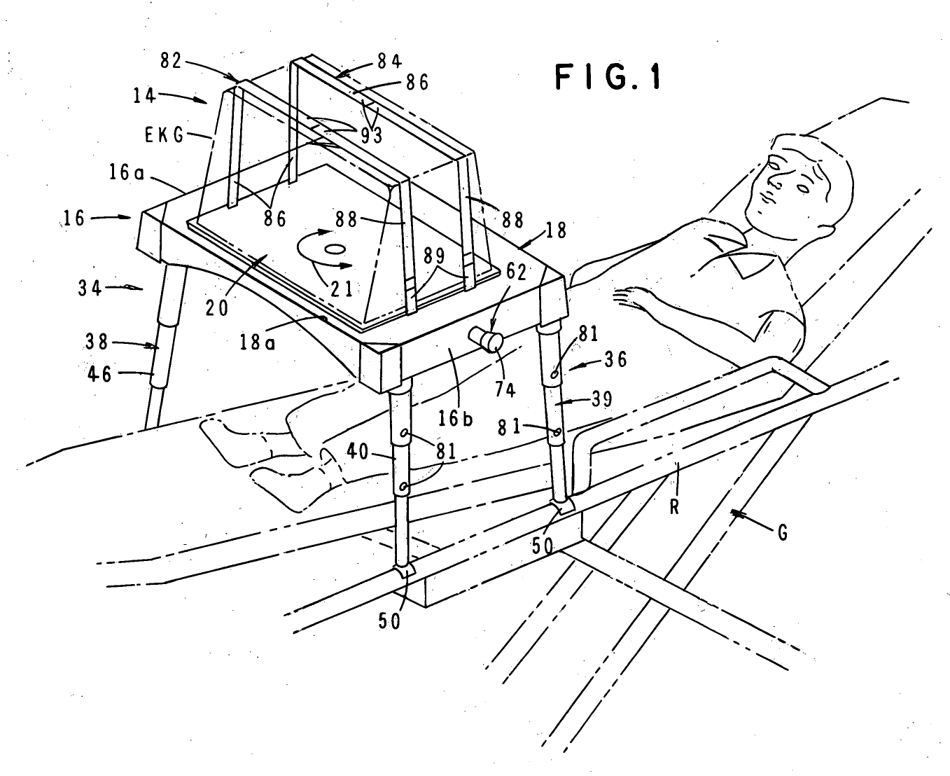

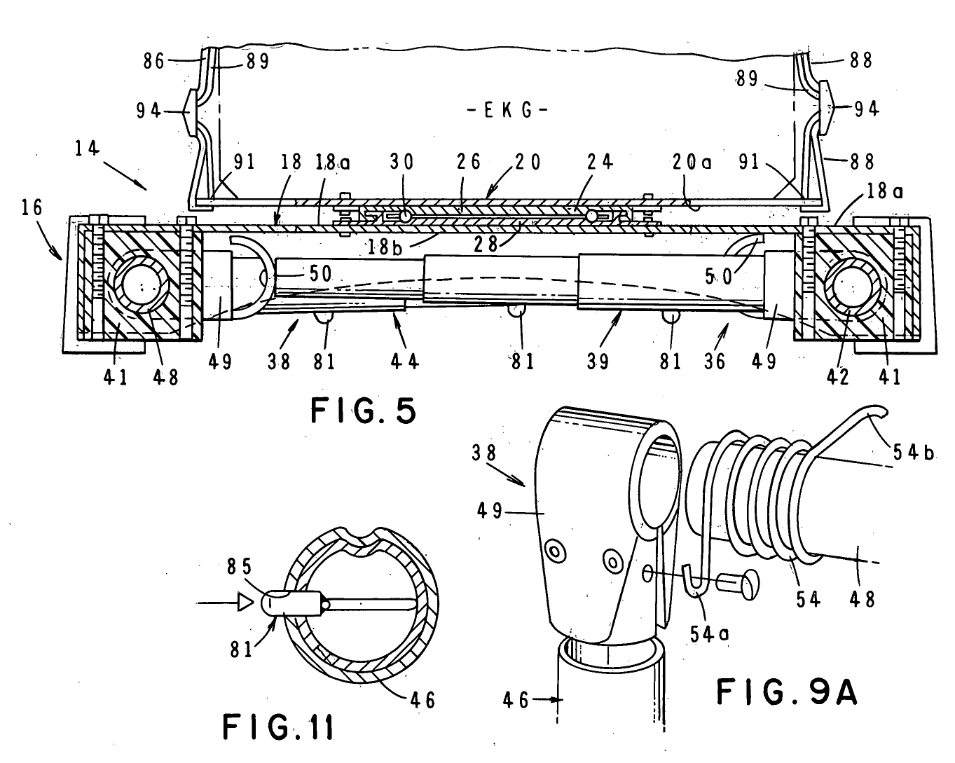

Referring to the drawings and particularly to FIGS. 1, 2 and 3 one form of the apparatus of the invention for securely holding elements of critical care equipment in close proximity to a patient lying on patient transport device, such as a gurney “G”, is there shown and generally designated by the numeral 14. Apparatus 14 here comprises an equipment support assembly 16 that includes a base 18 having an upper surface 18a and a lower surface 18b (FIG. 5). Apparatus 14 also includes an equipment support platform 20 that is connected to the upper surface 18a of the base 18 for swiveling movement relative thereto in the manner indicated by the arrow 21 in FIG. 1 of the drawings. More particularly, as best seen in FIG. 5, this swiveling movement is made possible through the use of a turntable assembly 24 that is disposed between the upper surface 18a of base 18 and the lower surface 20a of equipment support platform 20. Turntable assembly 24 here comprises an upper plate 26, a lower plate 28 and a turntable bearing assembly 30 that is disposed intermediate the upper and lower plates. Turntable bearing assembly 30 is of conventional design and is readily commercially available from various sources, including Cabinet Accessories of Turnbul, Conn.

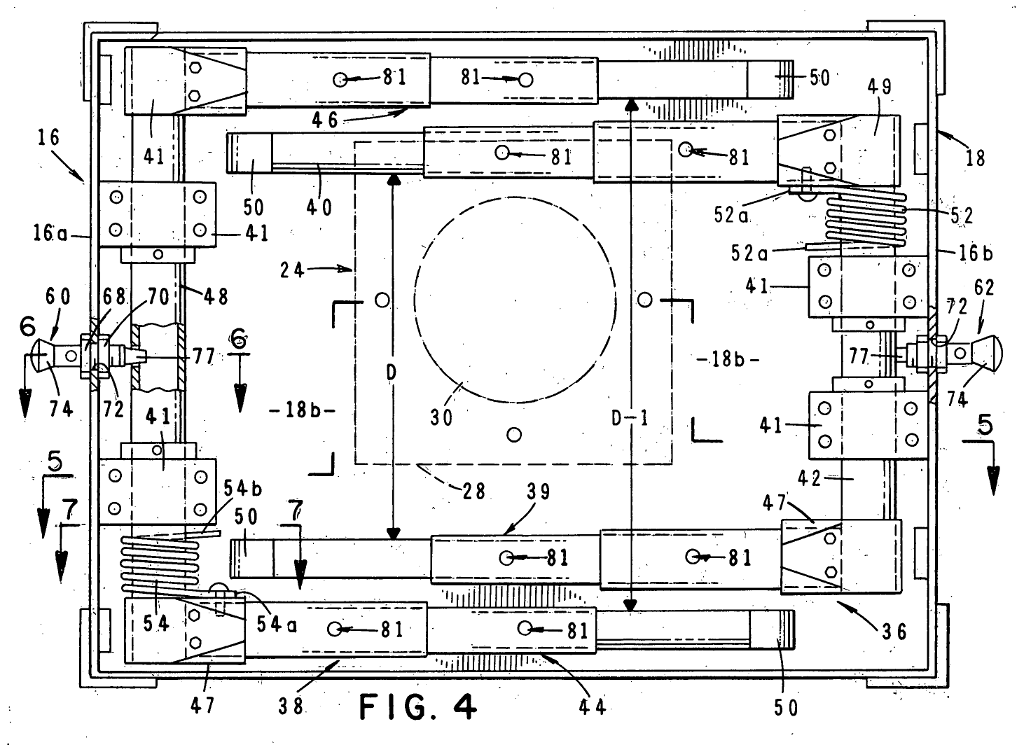

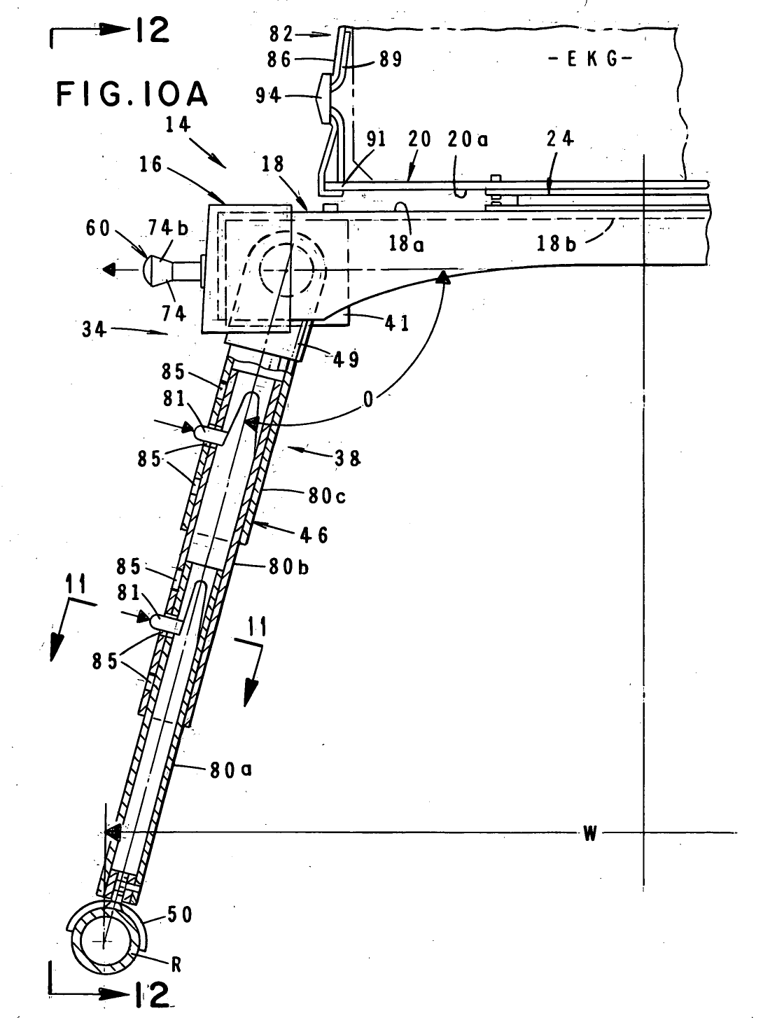

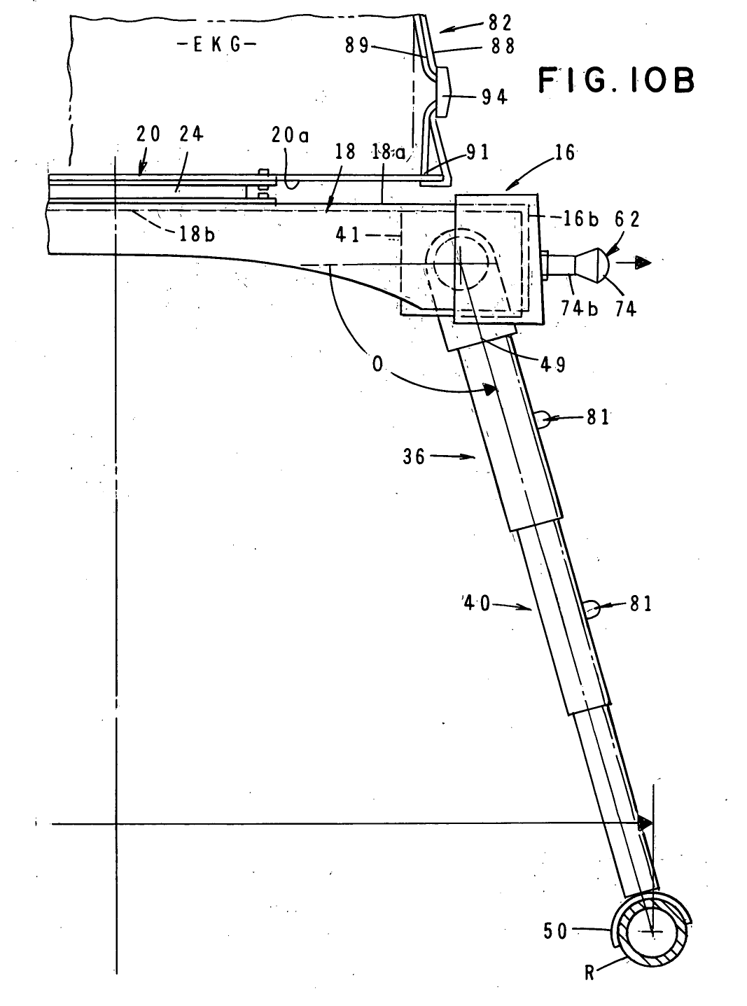

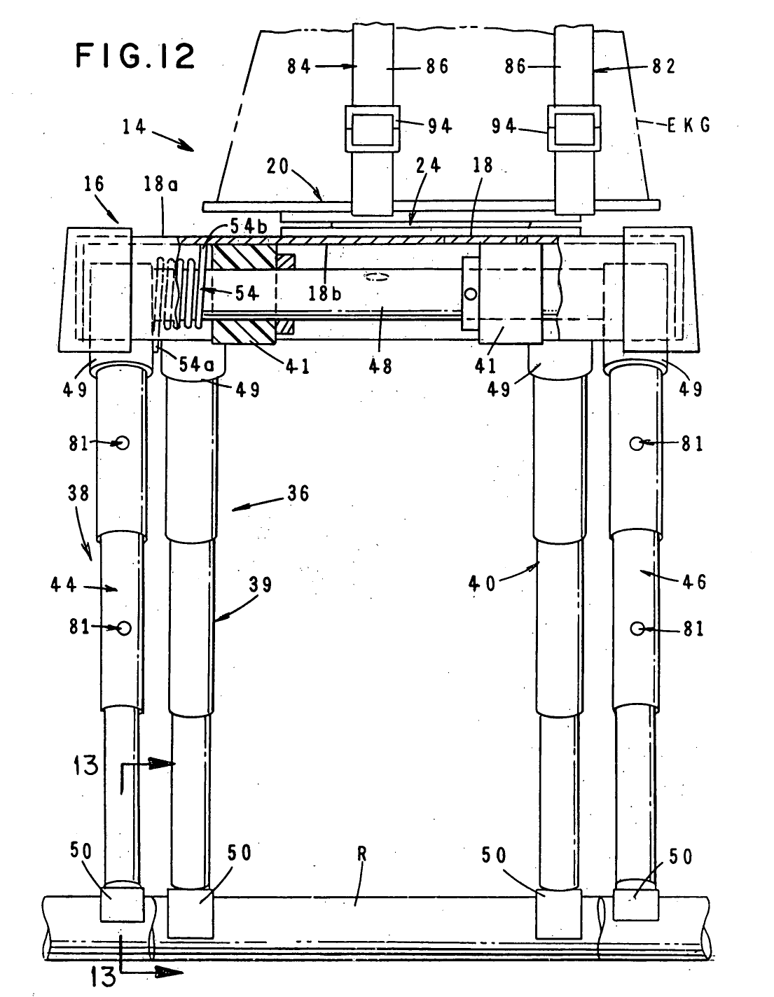

Apparatus 14 also includes a connector assembly 34 that is connected to the equipment support assembly 16 in the manner illustrated in FIGS. 1, 3, 10A and 10B. Connector assembly 34 functions to releasably connect the equipment support assembly 16 to the patient transport device, or gurney “G”, in the manner illustrated in FIG. 1 of the drawings. This novel connector assembly here comprises first and second pairs of spaced-apart, generally U-shaped leg assemblies 36 and 38 respectively (see FIG. 4). As best seen in FIGS. 10A and 10B, each support leg assembly 36 and 38 is pivotally connected to the lower surface 18b of base 18 by suitable conventional connector brackets 41 and extends there at an obtuse angle Turning to FIG. 4 of the drawings, it can be seen that support leg assembly 36 includes first and second spaced apart telescoping legs 39 and 40 that are interconnected by a bight portion 42. Similarly, support leg assembly 38 includes first and second spaced apart telescoping legs 44 and 46 that are interconnected by a bight portion 48. As indicated in FIG. 9A, each of the legs of the leg assemblies 36 and 38 is connected to its respective bight portions by a commercially available elbow 49.

In order that the leg assemblies 36 and 38 can conveniently fold and nest into their retracted position in the manner shown in FIG. 4, the first and second legs 39 and 40 of the first support leg assembly 36 are spaced apart by a first distance “D”, while the first and second legs 44 and 46 of the second support leg assembly 38 are spaced apart by a second distance “D−1” that is greater than first distance “D”. With this novel construction, the leg assemblies can be pivoted from their extended position shown in FIG. 1 to their retracted position shown in FIG. 4 in a manner such that the leg assemblies are nested and are disposed in close proximity with the lower surface 18b of base 18 of the support assembly 16.

In order to connect the apparatus of the invention to the gurney “G” in the manner shown in FIG. 1, each of the spaced apart support legs of each of said first and second support leg assemblies includes a generally “U” shaped connector foot 50 for engagement with a selected one of the transversely spaced apart side rails “R” of the patient transport device (see, for example, FIGS. 10A and 10B).

As illustrated in FIG. 4, connector assembly 34 further includes biasing means that is operably associated with base 18 of the equipment support assembly for urging the first and second support leg assemblies 36 and 38 of the connector assembly toward the lower surface 18b of base 18. In the present form of the invention, this biasing means comprises conventional torsion springs 52 and 54. As indicated in FIGS. 4, 7 and 9, torsion spring 52 circumscribes bight portion 42 of leg assembly 36 with end 52a thereof, being connected to leg 39 and end 52b thereof, being in engagement with the lower surface 18b of base 18. Similarly, torsion spring 54 circumscribes bight portion 48 of leg assembly 38 in the manner shown in FIG. 4 with end 54a thereof, being connected to leg 46 and end 54b thereof, being in engagement with the lower surface 18b of base 18. As illustrated in FIGS. 7 and 9, with the construction thus described, torsion spring 54 yieldably resists movement of leg assembly 38 from the retracted position shown in FIGS. 4 and 7 toward the extended position shown in FIGS. 1 and 9. Similarly, torsion spring 52 yieldably resists movement of leg assembly 36 from the retracted position shown in FIG. 4 toward the extended position shown in FIG. 1.

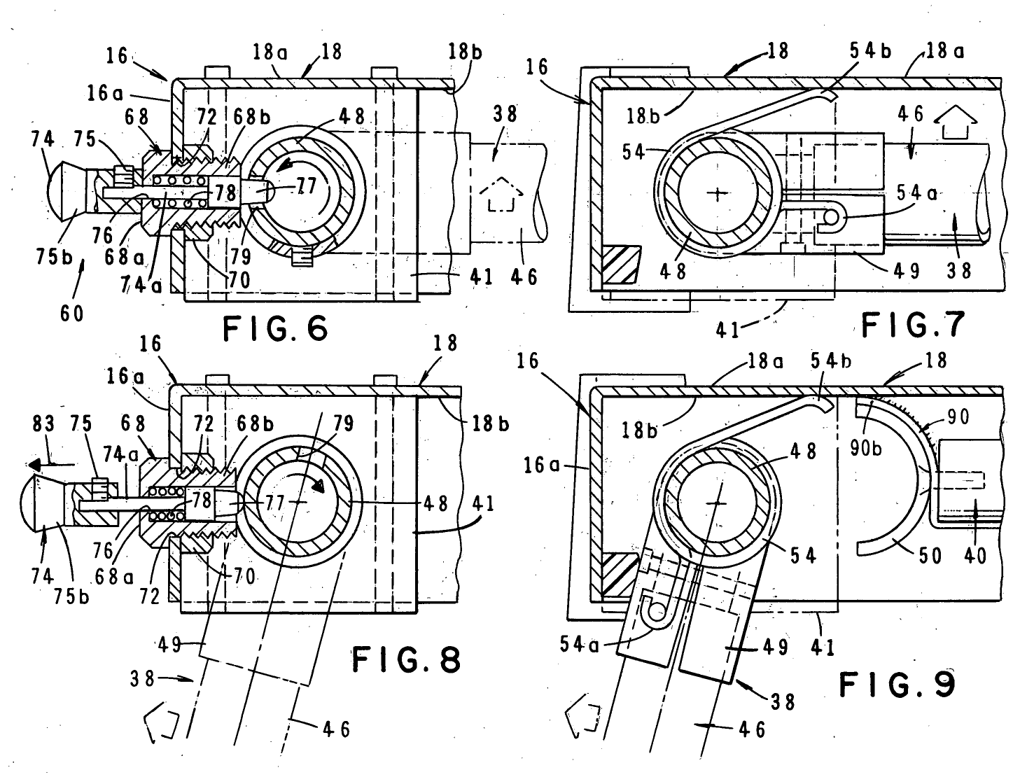

In order to releasably lock the first and second leg assemblies 36 and 38 in their retracted position as illustrated in FIG. 4, equipment support assembly 16 further includes locking means that are connected to the sidewalls 16a and 16b of the equipment support assembly. These novel locking means here comprise first and second pull pin locking assemblies 60 and 62. Pull pin locking assembly 60 is mounted on the side wall 16a of equipment support assembly 16, while pull pin locking assembly 62 is mounted on side wall 16b of equipment support assembly 16. Each of the pull pin locking assemblies 60 and 62 is of substantially identical construction and operation and each is of the construction illustrated in FIGS. 6 and 8 of the drawings. As illustrated in FIG. 6, each assembly 60 and 62 comprises a hollow housing 68 having a base wall 68a and a threaded shank portion 68b that threadably receives a locking ring 70. Shank portion 68b is received within apertures 72 formed in each of the sidewalls 16a and 16b of the equipment support assembly 16 and is secured in position within the apertures by locking rings 70. Each locking assembly 60 and 62 includes a pull pin 74 that has a locking pin portion 74a and a head portion 75b that is connected to pin portion 74a by a set screw 75. Locking pin portion 74a extends through an aperture 75 formed in end wall 68 and into hollow housing 68. Disposed within hollow housing 68 is a coil spring 78 that continuously urges pin portion 74a into locking engagement with the bight portion of the adjacent leg assembly in the manner shown in FIG. 6. More particularly, coil spring 78 continuously urges the tip 77 of the pin portion into an aperture 79 formed in the adjacent bight portion. To release the adjacent leg assembly so that it can be folded downwardly, the pull pin is pulled outwardly in the direction of the arrow 81 of FIG. 8 against the urging of coil spring 78 to move the tip 77 of the pin portion out of aperture 79 so as to permit rotation of the bight portion in the manner indicated in FIGS. 8 and 9.

Each of the telescoping legs of the leg assemblies 36 and 38 is of the construction illustrated in FIGS. 10A and 11. More particularly, each leg comprises first, second and third segments 80a, 80b and 80c. A pair of spring loaded detent assemblies 81 of conventional construction and operation (see FIGS. 10A and 11) releasably maintains the legs in the extended position shown in FIG. 10A.

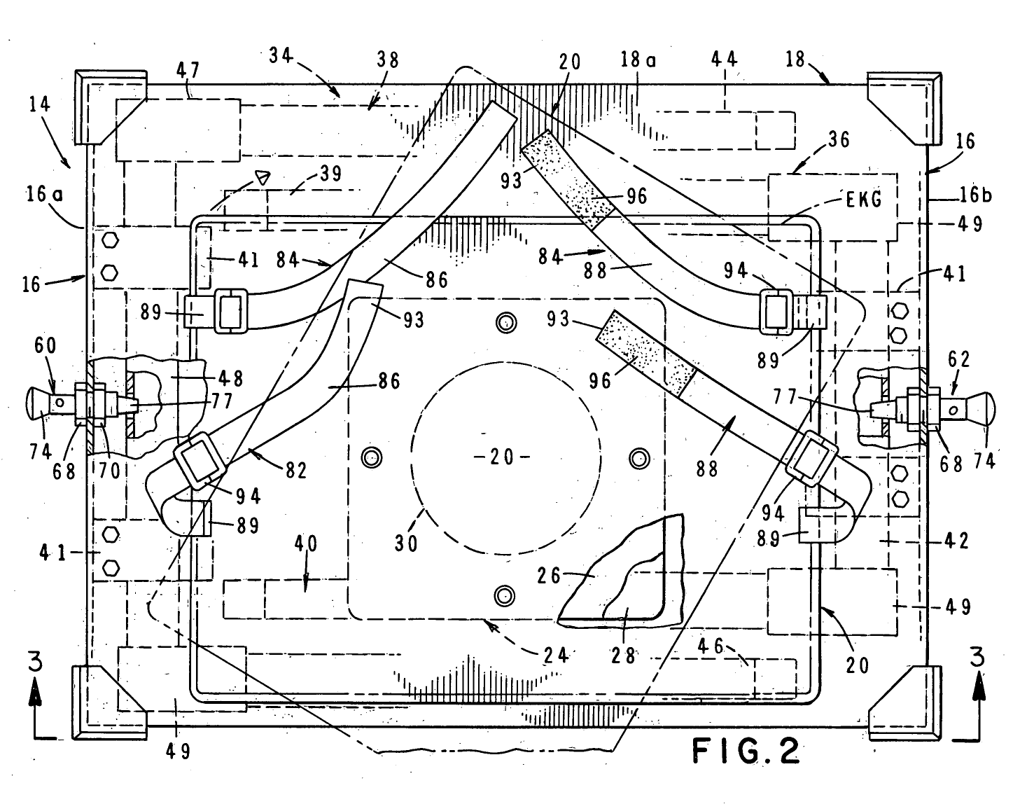

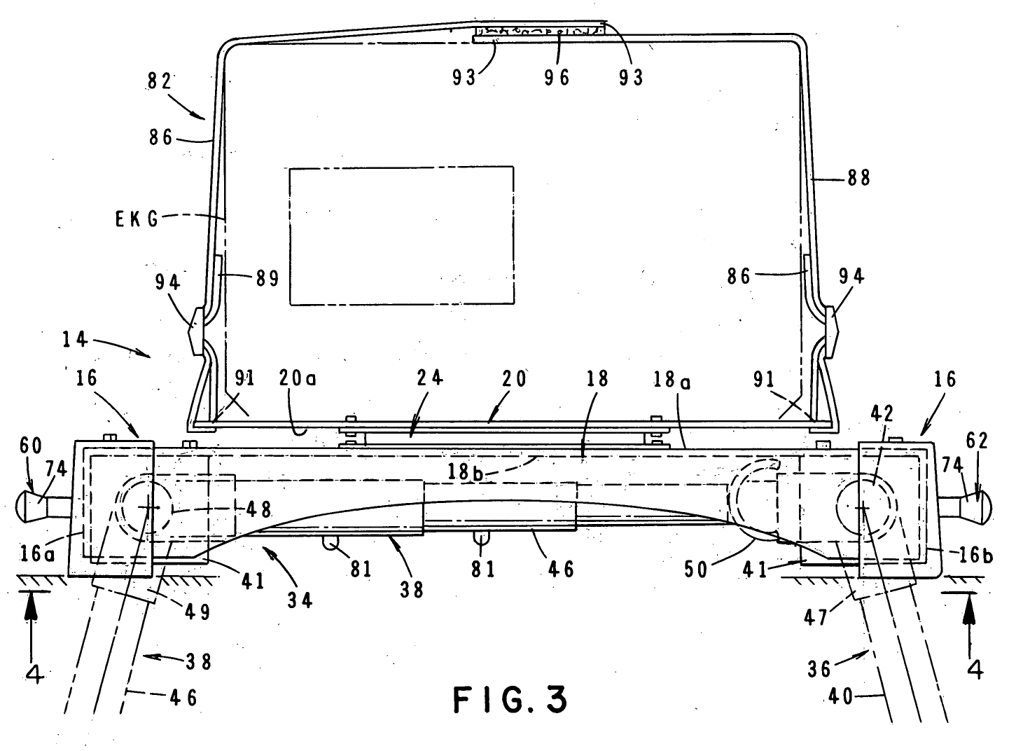

As illustrated in FIGS. 1, 2, 3 and 5 of the drawings, elements of the emergency medical equipment, such as an EKG unit, are secured to the equipment support platform 20 by means of first and second flexible strap assemblies 82 and 84. Flexible strap assemblies 82 and 84, which are substantially identical in construction and operation, each comprises first and second releasably inter-connectable straps 86 and 88 that may be wrapped around the emergency medical equipment in the manner illustrated in FIGS. 1 and 3. Each of the straps 86 and 88 has a first end 89 that extends through slots 91 formed in equipment support platform 20 (FIG. 3) and a second end 93. First ends 89 are connected to equipment support platform 20 by conventional buckles 94 in the manner shown in FIGS. 3 and 5. After the straps are positioned around the emergency medical equipment, such as the EKG, the second ends 93 of the straps are connected together by suitable fastening devices, such as connectors 96 sold under the name and style VELCRO® (FIGS. 2 and 3). In this way, the medical equipment is securely affixed to the support platform 20.

In using the apparatus of the invention and with the apparatus in the configuration shown in FIG. 4, wherein the leg assemblies are folded into their stowed position, the emergency medical equipment such as the EKG is secured to the support platform 20 by strap assemblies 82 and 84 in the manner shown in FIG. 1. With the apparatus in this configuration, it can be easily stored, or transported from place to place as may be required.

When the apparatus is to be used in an emergency situation the apparatus can be carried in the folded configuration to the location at which the apparatus is to be affixed to a patient transport device, such as gurney “G”. The locking means 60 and 62 are then operated in the manner previously described to permit the leg assemblies to be moved from the retracted stowed position shown in FIG. 4 of the drawings to the extended operative position shown in FIG. 1. With the legs in the extended position, U-shaped connector feet 50 can be positioned in engagement with the gurney rails “R” in the manner shown in FIG. 1.

An important feature of the apparatus of the invention resides in the fact that, if the rails of the gurney are spaced apart a greater distance than that shown in FIG. 1 of the drawings (for example, see FIG. 14 wherein the legs are spaced apart by a distance “W−1” which is greater than the distance “W” between the legs shown in FIG. 1), the apparatus can be adjusted to accommodate this wider spacing by outwardly telescoping each of the legs of the leg assemblies so as to accommodate the width “W−1”. Conversely, if the rails of the gurney are spaced apart a distance less than the distance “D”, this distance can be accommodated by telescoping the legs inwardly rather than outwardly so as to decrease the distance that the legs are spaced apart. As indicated in FIG. 10A each of the legs of the leg assemblies is provided with spaced-apart, detent head receiving apertures 85 so that the legs can be locked in the desired position. This novel leg adjustability feature of the apparatus of the invention allows the apparatus to be used with gurneys, stretchers or the like, which have rails that are spaced different distances apart.

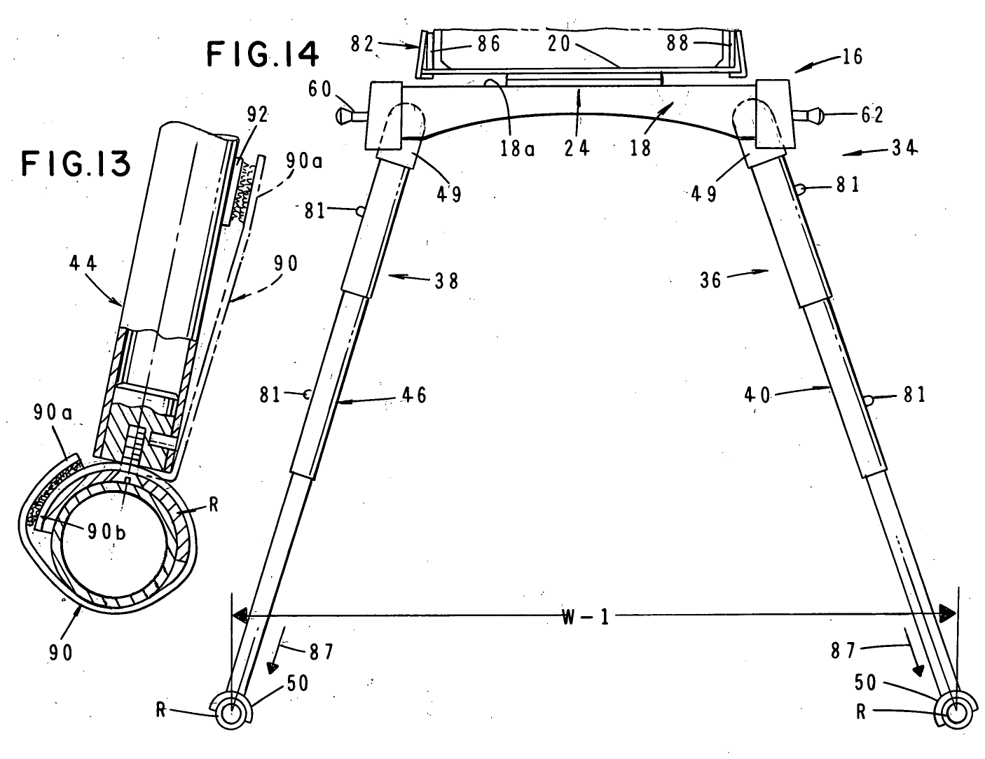

In an alternate form of the invention shown in FIG. 13 of the drawings, a leg securement strap 86 is provided that can be used to releasably interconnect each of the legs with a selected rail “R” of the gurney. Securement strap 86 here comprises an elongated strap having first and second ends 86a and 86b, each of which is provided with a suitable connector device such as connectors sold under the name and style VELCRO®. To releasably interconnect end 86a to a selected leg, a second connector device such as a connector 88 sold under the name and style VELCRO® is affixed to the lower portion of the leg in the manner shown in FIG. 13. In similar fashion, the second end of the securement is provided with mating connector devices so that once the strap is securely wound about the connector foot 50 and the gurney rail “R”, the strap can be snugged down and secured in position in the manner illustrated in FIG. 13 to thereby releasably affix the leg assembly to the rail “R”.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following Claims.

I claim:

1. Apparatus for securely holding elements of critical care equipment in close proximity to a patient lying on patient transport device of the character having transversely spaced-apart rails, the apparatus comprising:
(a) an equipment support assembly, including a base having an upper and lower surface and an equipment support platform connected to said upper surface of said base for swiveling movement relative thereto; and
(b) a connector assembly connected to said equipment support assembly for connecting said equipment support assembly to the patient transport device, said connector assembly comprising first and second support leg assemblies connected to said base of said equipment support assembly, each said first and second support leg assemblies comprising spaced apart legs extending from said base at an obtuse angle.

2. The apparatus as defined in claim 1 in which each of said first and second support leg assemblies is generally “U” shaped.

3. The apparatus as defined in claim 2 in which each of said spaced apart legs of each of said first and second support leg assemblies is telescoping.

4. The apparatus as defined in claim 3 in which said spaced apart legs of said first support leg assembly are spaced apart by a first distance and in which said spaced apart legs of said second support leg assembly are spaced apart by a second distance greater than said first distance.

5. The apparatus as defined in claim 3 in which each leg of said spaced apart legs of each of said first and second support leg assemblies includes a generally “U” shaped connector foot for engagement with a selected one of the transversely spaced-apart rails of the patient transport device.

6. The apparatus as defined in claim 3 in which each of said first and second support leg assemblies of said connector assembly is pivotally connected to said base of said equipment support assembly for movement between an extended position and a retracted position wherein said first and second support leg assemblies are disposed in close proximity to said lower surface of said base of said equipment support assembly.

7. The apparatus as defined in claim 6 in which said connector assembly further includes biasing means operably associated with said base of said equipment support assembly for urging said first and second support leg assemblies of said connector assembly toward said lower surface of said base of said equipment support assembly.

8. The apparatus as defined in claim 7 in which said equipment support assembly further includes locking means connected to said base of said equipment support assembly for releasably locking said first and second support leg assemblies of said connector assembly in said retracted position.

9. The apparatus as defined in claim 8 in which said locking means comprises first and second pull pin assemblies connected to said equipment support assembly.

10. An apparatus for securely holding elements of critical care equipment in close proximity to a patient lying on patient transport device of the character having transversely spaced-apart rails, the apparatus comprising:
(a) an equipment support assembly, including a base having an upper and lower surface and an equipment support platform connected to said upper surface of said base for swiveling movement relative thereto; and
(b) a connector assembly connected to said equipment support assembly for connecting said equipment support assembly to the patient transport device, said connector assembly comprising first and second generally “U” shaped support leg assemblies connected to said base of said equipment support assembly, each said first and second support leg assemblies comprising spaced apart telescoping legs extending from said base at an obtuse angle.

11. The apparatus as defined in claim 10 in which said spaced apart legs of said first support leg assembly are spaced apart by a first distance and in which said spaced apart legs of said second support leg assembly are spaced apart by a second distance greater than said first distance.

12. The apparatus as defined in claim 11 in which each of said spaced apart legs of each of said first and second support leg assemblies includes a generally “U” shaped connector foot for engagement with a selected one of the transversely spaced-apart rails of the patient transport device.

13. The apparatus as defined in claim 12 in which each of said first and second support leg assemblies of said connector assembly is pivotally connected to said base of said equipment support assembly for movement between an extended position and a retracted position wherein said first and second support leg assemblies are disposed in close proximity to said lower surface of said base of said equipment support assembly.

14. The apparatus as defined in claim 13 in which said connector assembly further includes biasing means operably associated with said base of said equipment support assembly for urging said first and second support leg assemblies of said connector assembly toward said lower surface of said base of said equipment support assembly.

15. The apparatus as defined in claim 14 in which said equipment support assembly further includes locking means connected to said base of said equipment support assembly for releasably locking said first and second support leg assemblies of said connector assembly in said retracted position, said locking means comprising first and second pull pin assemblies connected to said equipment support assembly.

16. Apparatus for securely holding elements of critical care equipment in close proximity to a patient lying on patient transport device of the character having transversely spaced-apart rails, the apparatus comprising:
(a) an equipment support assembly, including a base having an upper and lower surface and an equipment support platform connected to said upper surface of said base for swiveling movement relative thereto;
(b) a connector assembly connected to said equipment support assembly for connecting said equipment support assembly to the patient transport device, said connector assembly comprising first and second generally “U” shaped support leg assemblies pivotally connected to said base of said equipment support assembly for movement between an extended position and a retracted position wherein said first and second support leg assemblies are disposed in close proximity to said lower surface of said base of said equipment support assembly, each said first and second support leg assemblies comprising spaced apart telescoping legs extending from said base at an obtuse angle;
(c) a generally “U” shaped connector foot connected to each of said spaced apart telescoping legs for engagement with a selected one of the transversely spaced-apart rails of the patient transport device; and
(d) biasing means operably associated with said base of said equipment support assembly for urging said first and second support leg assemblies of said connector assembly toward said lower surface of said base of said equipment support assembly.

17. The apparatus as defined in claim 16 in which said spaced apart legs of said first support leg assembly are spaced apart by a first distance and in which said spaced apart legs of said second support leg assembly are spaced apart by a second distance greater than said first distance.

18. The apparatus as defined in claim 17 in which said connector assembly further includes biasing means operably associated with said base of said equipment support assembly for urging said first and second support leg assemblies of said connector assembly toward said lower surface of said base of said equipment support assembly.

19. The apparatus as defined in claim 18 in which said equipment support assembly further includes locking means connected to said base of said equipment support assembly for releasably locking said first and second support leg assemblies of said connector assembly in said retracted position, said locking means comprising first and second pull pin assemblies connected to said equipment support assembly.

20. The apparatus as defined in claim 19 further including first and second flexible strap assemblies connected to said equipment support platform for securing elements of critical care equipment to said equipment support platform.
